(19) United States
(12) Patent Application Publication
(10) Pub. No.: US 2009/0096345 A1
(43) Pub. Date: Apr. 16, 2009

(54) Uniquely designed internal combustion engine spark plug that will produce two independent ignition sparks between the spark plug electrodes for each single electrical ignition coil discharge

(76) Inventor: Thad Whitfield Posey, Warrenton, VA (US)

Correspondence Address: Thad W. Posey, 7591 Cannoneer Ct., Warrenton, VA, 20186, US

(21) Appl. No.: 11/974,593

(22) Filed: Oct. 16, 2007

(51) Int. Cl. H01T 13/26

(52) U.S. Cl. 313/141

(57) ABSTRACT

This invention is an improvement to the internal combustion engine spark plug used to ignite the fuel air mixture in the engine combustion chamber. All spark plugs manufactured today produce one ignition spark for each high voltage electrical discharge of the ignition coil regardless of the number of spark plug electrodes used in the manufacture of the spark plug. This invention uses an intermediate electrically neutral electrode placed between the spark plug center electrode and the ground strap electrode creating two separate spark air gaps. For each single high voltage electrical discharge of the ignition coil, a spark will occur between the center electrode and the intermediate electrode and another distinct and separate spark will occur between the intermediate electrode and the ground strap electrode. Because the two ignition sparks are electrically in series, both will have the same electrical energy.

### BACKGROUND OF THE INVENTION

This invention is a uniquely designed spark plug for use in all internal combustion engines where spark plugs are used to ignite the fuel/air mixture in the engine combustion chamber. It is well know in the industry that lean fuel/air mixtures necessary for emissions control and good fuel economy require a strong ignition system with a long spark duration. Improvements have been made in modern ignition systems related to the ignition coil and control modules but little has been done other than minor shaping of the electrodes to actually improve the spark plug ignition performance. With the use of harder metals in the spark plug electrodes and the use of multiple ground strap electrodes, the service life of modern spark plugs have been greatly extended. But, regardless of the configuration, all spark plugs currently on the market today produce only one spark at a time for each electrical discharge of the ignition coil.

This invention is a uniquely constructed spark plug designed to create two independent ignition sparks at the spark plug electrodes for each single electrical discharge of the ignition coil. The two independent sparks are electrically in series ensuring both sparks have the same electrical energy for superior ignition of the fuel/air mixture in an engine's combustion chamber thereby reducing exhaust emissions and improving engine efficiency.

### BRIEF SUMMARY OF THE INVENTION

This uniquely designed spark plug incorporates an intermediate electrode that is placed between the conventional center and ground strap electrodes and is electrically insulated from the center and ground strap electrodes making it electrically neutral. The intermediate electrode so placed forms two spark air gaps. One ignition spark air gap between the center electrode and the intermediate electrode and another between the intermediate electrode and the ground strap electrode. With each single electrical discharge of the ignition coil, a spark will be emitted from the center electrode to the intermediate electrode and another from the intermediate electrode to the ground strap electrode.

The double ignition sparking of this spark plug for each single electrical discharge of the ignition coil greatly enhances ignition of the fuel air mixture in the combustion chamber. The two sparks emitted by this spark plug are physically separated therefore ignition of the fuel air mixture occurs in two places greatly improving the combustion process which reduces harmful emissions and improves engine efficiency. Because the two independent ignition sparks are electrically in series, they are of equal electrical energy with no loss of ignition spark energy in this configuration.

### BRIEF DESCRIPTION OF VIEWS OF DRAWINGS

FIG. 1 depicts a spark plug as viewed from the bottom, electrode end, constructed with an intermediate electrode fixed to the center electrode insulator in the form of a round or flat or similarly shaped wire electrode forming two spark air gaps.

FIG. 2 depicts a spark plug as viewed from the bottom, electrode end, constructed with an intermediate electrode fixed to the center electrode insulator in the form of a half circle, 180 degrees or partially surrounding the center electrode forming two spark air gaps.

FIG. 3 depicts a spark plug as viewed from the bottom, electrode end, constructed with an intermediate electrode fixed to the center electrode insulator in the form of a complete circle, 360 degrees surrounding the center electrode forming two spark air gaps.

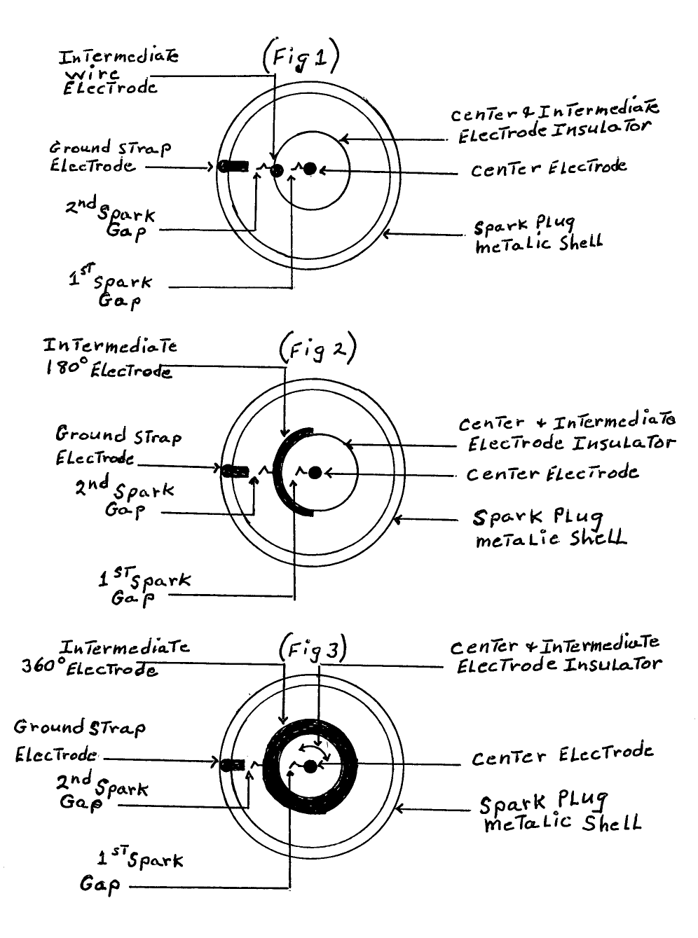

### DETAILED DESCRIPTION OF THE INVENTION

This invention is an improvement to the conventional spark plug used in internal combustion engines. All spark plugs manufactured today are capable of producing only a single spark for each single electrical discharge of the ignition coil regardless of the number of spark plug electrodes used in a particular design.

This spark plug improvement invention incorporates a third intermediate electrode mounted between the center electrode of a conventional spark plug and the ground strap electrode and is configured to provide a spark air gap between the center electrode and the intermediate electrode as well as a spark air gap between the intermediate electrode and the ground strap electrode. The intermediate electrode is electrically insulated from the center electrode and the ground strap electrode making it electrically neutral. It is well known by those skilled in the science of high voltage conductivity that electrical energy will easily conduct to most electrically conductive materials without being directly referenced to the power source when electrical voltages are sufficient. Extensive tests have shown that virtually all ignition systems in use today produce sufficient secondary coil voltages, ranging from approximately 15K volts to 40K volts to readily conduct to the electrically neutral intermediate electrode once the air gap has been ionized by the ignition coil high voltage. When this happens, a spark is generated from the center electrode to the intermediate neutral electrode immediately followed by another spark from the intermediate neutral electrode to the ground strap electrode. The intermediate neutral electrode acts as an air gap conductor actually aiding conduction of the electrical energy in the form of two distinct ignition sparks. In extensive tests performed on this spark plug invention, no electrical spark energy loss was observed when the ignition sparks were conducted through the electrically neutral intermediate electrode.

The intermediate spark plug electrode can be fashioned as a single wire electrode between the center spark plug electrode and the ground strap electrode or as a semi-circle electrode partially encircling the center spark plug electrode or made to encircle the center spark plug electrode a full 360 degrees to provide multiple spark conduction paths to the intermediate neutral electrode.

The intermediate electrode can be made from any suitable material commonly used in spark plug electrodes that are electrically conductive such as ferrous, alloys, palladium alloys, platinum, and iridium but are not limited to those materials.

The intermediate neutral electrode is electrically insulated from the center spark plug electrode and from the ground strap electrode. The intermediate neutral electrode is connected to the extended tip center electrode insulator and becomes part of that insulator in the manufacturing process with only the electrical conduction part of the electrode left un-insulated for conduction of the ignition spark. The spark air gap will be preset in the manufacturing process at various dimensions depending on application requirements. The intermediate electrode insulator material can be insulator material commonly used in the manufacturer of spark plugs such as aluminum oxide material.

1. An internal combustion engine combustion chamber igniter commonly referred to as a spark plug with a third intermediate electrode electrically insulated from the center electrode and from the ground strap electrode and placed between the center and ground strap electrodes to form two separated spark air gaps thereby providing an electrical conduction path for two distinct and separate ignition sparks in electrical series for each single inductive electrical discharge of the ignition coil.

2. A spark plug constructed as described in claim 1 where the intermediate electrode is a wire electrode either round or flat or similarly shaped, placed between the center electrode and the ground strap electrode to form two separate spark air gaps.

3. A spark plug constructed as described in claim 1 where the intermediate electrode is in the form of a partial circle surrounding the center electrode and placed between the center electrode and the ground strap electrode to form two separate spark air gaps.

4. A spark plug constructed as described in claim 1 where the intermediate electrode is in the form of a complete circle, 360 degrees surrounding the center electrode and placed between the center electrode and the ground strap electrode to form two separate spark air gaps.

5. A spark plug constructed as described in claim 1 where the intermediate electrode forms two separate ignition spark air gaps in electrical series so that the two distinct and separate sparks will have equal electrical energy for each single inductive electrical discharge of the ignition coil.

6. A spark plug constructed as described in claim 1 where the intermediate electrode can be made from any suitable electrical conductive material commonly used in conventional spark plug electrodes such as ferrous alloys, platinum, iridium and palladium alloys and bonded materials but not limited to such materials.
